(19) United States
(12) Patent Application Publication
(10) Pub. No.: US 2007/0013199 A1
(43) Pub. Date: Jan. 18, 2007

(54) Clamping assembly

(75) Inventors: David R. Hall, Provo, UT (US); Jay Reynolds, Provo, UT (US)

Correspondence Address: TYSON J. WILDE;NOVATEK INTERNATIONAL, INC., 2185 SOUTH LARSEN PARKWAY, PROVO, UT, 84606, US

(73) Assignee: Novatek International, Inc.

(21) Appl. No.: 11/179,975

(22) Filed: Jul. 12, 2005

(51) Int. Cl. B66C 1/42

(52) U.S. Cl. 294/106; 294/81.61

(57) ABSTRACT

A clamping assembly for use in gripping, grabbing, supporting, sensing and transporting objects of varying size, shape and weight is disclosed. The clamping assembly has opposed jaws each with a ball and socket apparatus intermediate a clamp end and a pivot end attached to a frame structure. The ball and socket apparatuses are connected by a gear assembly with a primary gear in mechanical communication with a power source wherein, the jaws are actuated in accordance with the rotation of the primary gear.

### BACKGROUND OF THE INVENTION

The present invention pertains to clamping assemblies, specifically clamping assemblies used in manufacturing and material handling. While transporting large objects a clamping assembly may be desired. In the prior art, several references disclose apparatuses and methods for gripping, grabbing, supporting, sensing and transporting objects of varying size and weight.

U.S. Pat. No. 4,432,691, which is herein incorporated by reference for all that it discloses, discloses a self-contained power-operated manipulator for piping and the like and is capable of coordinated movements which approximate those of the human arm and hand.

U.S. Pat. No. 5,184,861, which is herein incorporated by reference for all that it discloses, discloses a split rail gripper for robotic apparatus and including a pair of rails which are driven in mutually opposite directions by a rack and pinion gear mechanism. Each rail includes a set of rack gear teeth which engage respective pinion gears and where the top rail engaging one of the pinion gears is driven by a harmonic gear reduction drive and motor unit coupled to a drive screw. The other pinion gear is driven by the top pinion gear engaging a set of rack gear teeth included in the bottom rail. As the top rail is driven in or out, the upper pinion gear is rotated, causing the other pinion gear, in turn, to rotate in the opposite direction. This causes the bottom rail to move in an opposite linear direction relative to the top rail. An outwardly extending gripper finger assembly is attached to respective ends of the rails, with each gripper finger including an arrangement of vertically and horizontally mounted roller members which operate to automatically center and engage an H-plate type interface secured to the object being grasped. The gripper assembly also includes a base plate attached to an interface plate of a robotic tool changer mechanism. A retractable rotary tool driver and tool is also centrally mounted on the base plate.

U.S. Pat. No. 6,820,849, which is herein incorporated by reference for all that it discloses, discloses a clamping device including a fixed jaw attached to one end of a threaded shaft and an adjustable jaw which is movably mounted on the threaded shaft.

U.S. Pat. No. 4,604,724, which is herein incorporated by reference for all that it discloses, discloses an automated apparatus for handling elongated well elements such as pipes. An automatic tong is provided for screwing and unscrewing pipes from a string of elongated well elements. A manipulator grips and delivers a pipe to an operation position in axial alignment with the well bore. A control system includes position sensors for sensing the position of a well pipe. The control unit also includes a programmed logical control unit through which the sensors are connected to a drive system.

U.S. Pat. No. 4,531,875, which is herein incorporated by reference for all that is discloses, discloses an automated pipe handling system for providing increased safety and to minimize the number of workmen required in the coupling and uncoupling of pipe stands. The system includes a programmable controller for monitoring and/or controlling devices which remove and add pipe stands to a drill column. A number of transducers are operatively connected to the controlled devices for communication with the programmable controller for use in verifying that the controlled devices have properly performed their programmed tasks. The controlled devices include upper and lower arm assemblies for use in engaging and moving the uncoupled pipe stands to a storage position. The controlled devices further include a finger board assembly and a set-back assembly. The finger board assembly moves and retains the upper portions of the pipe stands while a drill rig floor of a derrick supports their lower portions. The set-back assembly is used to hold the lower portions of the pipe stands and to move the pipe stands to the predetermined storage positions on the drill rig floor.

U.S. Pat. No. 6,846,331, which is herein incorporated by reference for all that it discloses, discloses a gripper device comprising at least two portions which are coupled together and which may be moved towards one another to effect a gripping action and away from one another to effect a release action. An electrical motor is arranged to effect such movement, and a battery is connected to supply electrical current to the motor. A capacitor device is also connected to be capable of supplying electrical current to the electrical motor. A control device is arranged to cause the capacitor device to supply electrical current to the electrical motor after supply of electrical current to the electrical motor by the battery, to increase the strength of the gripping action.

### BRIEF SUMMARY OF THE INVENTION

A clamping assembly for use in gripping, grabbing, supporting, sensing and transporting objects of varying size, shape and weight is disclosed. The clamping assembly has opposed jaws each with a ball and socket apparatus intermediate a clamp end and a pivot end attached to a frame structure. In one aspects of the invention, the frame structure may have a stabilizing member. The ball and socket apparatuses are connected by a gear assembly with a primary gear in mechanical communication with a power source wherein the jaws are actuated in accordance with the rotation of the primary gear.

The gear assembly may have a rod wherein the primary gear is intermediate oppositely threaded ends of the rod. The ends of the rod may be threadedly connected to the ball and socket apparatuses. The primary gear may be selected from the group consisting of spur gears, helical gears, crossed helical gears, bevel gears, spiral bevel gears, hypoid gears and zerol gears.

The primary gear may also be a pinion gear in mechanical communication with rack gears pivotally connected to the ball and socket apparatuses. As the pinion gear rotates the rack gears linearly extend out or retract in depending on the direction of rotation of the pinion gear.

The clamping assembly may have a sensor selected from the group consisting of torque sensors, pressure sensors, position sensors, strain sensors, optical sensors, sonic sensors, seismic sensors, acoustic sensors, inductive sensors, capacitive sensors, magnetic sensors, temperature sensors, vibrations sensors, sway sensors, smart sensors, and weight sensors.

The clamping assembly may move in a horizontal direction, a vertical direction or both directions with respect to the frame structure. The clamping assembly may also rotate axially or horizontally with respect to the frame structure.

The clamping assembly may have a control unit selected from the group consisting of integrated circuits, microprocessor chips and field-programmable gate array's (FPGA's). The control unit may receive operating instructions from an input device selected from the group consisting of controllers, remote controls, radio controls, sensors, memory and computers. The clamping assembly may also have memory.

The clamping assembly may comprise at least a portion of a closed loop system. The at least portion of the closed loop system may have elements selected from the group consisting of sensors, control units, transmission mediums, power sources, actuators, indicators and memory.

The power source may be selected from the group consisting of motors, engines and hydraulics. The power source may be in mechanical communication with the primary gear by a mechanical device selected from the group consisting of gears, belts, bands, wheels, pulleys, chains, ropes, rods, shafts and combinations of the above.

The clamp end may have a gripping surface selected from the group consisting of elastomer coated surfaces, grooved surfaces, curved surfaces and rough surfaces. The pivot end of the jaw may be attached to the frame structure by a connection selected the group consisting of hinges, swivels, ball and sockets apparatuses and pivots.

In other aspects of the invention a lifting assembly may comprise a clamping assembly with opposed jaws each having a ball and socket apparatus intermediate a clamp end and a pivot end attached to a frame structure of the lifting assembly. The ball and socket apparatuses are connected by a gear assembly comprising a primary gear in mechanical communication with a power source. Wherein, the jaws are actuated in accordance with the rotation of the primary gear.

The lifting assembly may have a sensor selected from the group consisting of torque sensors, pressure sensors, position sensors, strain sensors, optical sensors, sonic sensors, seismic sensors, acoustic sensors, inductive sensors, capacitive sensors, magnetic sensors, temperature sensors, vibrations sensors, sway sensors, smart sensors, and weight sensors.

The lifting assembly may comprise at least a portion of a closed loop system. The at least portion of the closed loop system may have elements selected from the group consisting of sensors, control units, transmission mediums, power sources, actuators, indicators and memory.

### BRIEF DESCRIPTION OF THE DRAWINGS

FIG. 1 is a perspective diagram of a lifting assembly comprising clamping assemblies.

FIG. 2 is a perspective diagram of a mobile lifting assembly comprising a clamping assembly.

FIG. 3 is a perspective cross-sectional diagram of a clamping assembly.

FIG. 4 is a perspective diagram of a clamping assembly.

FIG. 5 is a perspective cross-sectional diagram of a clamping assembly.

FIG. 6 is a perspective diagram of a clamping assembly.

FIG. 7 is a cross-sectional diagram of a clamping assembly.

FIG. 8 is a perspective diagram of a clamping assembly.

FIG. 9 is a perspective diagram of a frame structure with multiple clamping assemblies.

FIG. 10 is a perspective diagram of two clamping assemblies adapted to move horizontally along the frame structure.

FIG. 11 is an orthogonal diagram of two clamping assemblies adapted to rotate with respect to the frame structure.

FIG. 12 is a perspective diagram of a clamping assembly comprising a positioning sensor.

FIG. 13 is a perspective diagram of a clamping assembly with multiple sensors.

FIG. 14 is a perspective diagram of a clamping assembly with an indicator.

### DETAILED DESCRIPTION OF THE INVENTION AND THE PREFERRED EMBODIMENT

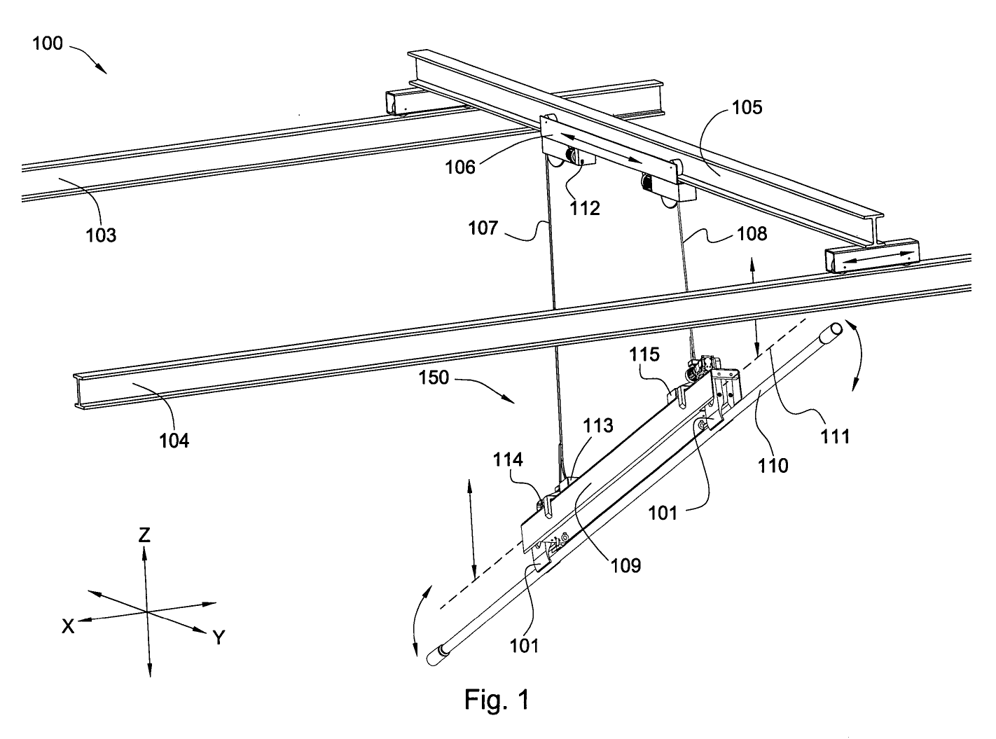

Referring now to the drawings, FIG. 1 is a perspective diagram of a lifting assembly 100 comprising clamping assemblies 101. The clamping assemblies 101 may be attached to a frame structure 109 along a common axis 111. The lifting assembly 100 may comprise two beams 103, 104 affixed parallel to each other and a third beam 105 perpendicular to the parallel beams 103, 104. The third beam 105 may be able to move along the parallel beams 103, 104 along an x-axis. The third beam 105 may comprise a gliding assembly 106 which may comprise cables 107, 108 attached to the frame structure 109 of the clamping assemblies 101. The gliding assembly 106 may be able to move along the third beam 105 along a y-axis as well as adjust the length of the cables 107, 108 attached to the frame structure 109 along a z-axis. Such an arrangement may allow the position, angle and the height of the frame structure 109 to be adjusted. This may be used for moving objects 110 from a horizontal position to a vertical position as diagramed in FIG. 1. This may be useful for a storage facility. The third beam 105 and gliding assembly 106 may comprise an anti-sway mechanism (not shown) adapted to control any swinging movements of the frame structure 109. The anti-sway mechanism may prevent the frame structure 109 from swinging by gradually starting and stopping any movement of the gliding assembly 106 or third beam 105.

The lifting assembly 100 may comprise a sensor 112 selected from the group consisting of torque sensors, pressure sensors, position sensors, strain sensors, optical sensors, sonic sensors, seismic sensors, acoustic sensors, inductive sensors, capacitive sensors, magnetic sensors, temperature sensors, vibrations sensors, sway sensors, smart sensors, and weight sensors.

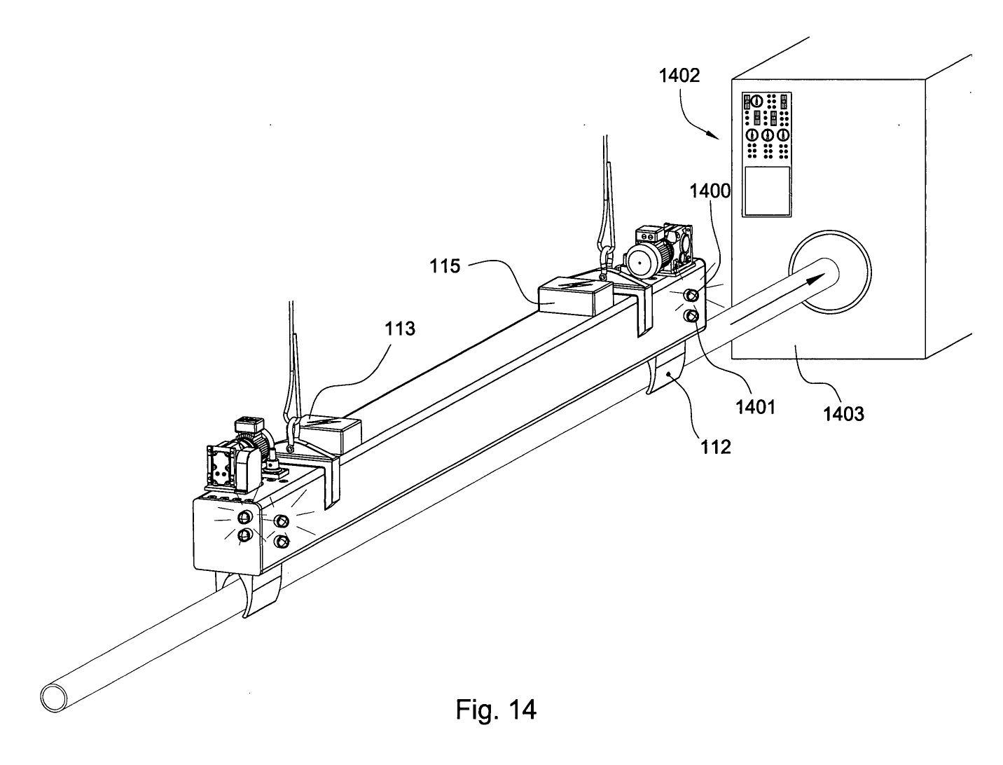

The lifting assembly 100 may comprise at least a portion of a closed loop system 150. The at least portion of the closed loop system 150 may comprise elements selected from the group consisting of sensors 112, control units 113, transmission mediums (not shown), power sources 114, actuators (not shown), indicators 1400, 1401 (see FIG. 14), and memory 115. The closed loop system 150 may perform the following method. A sensor 112 may detect the position of a desired object 110 relative to the clamping assemblies 101. The control unit 113 may send a signal through a transmission medium (not shown) to an actuator (not shown) to activate the power source 114 in order to position the clamping assemblies 101 over the object 110. When the clamping assemblies 101 are in position the control unit 113 may actuate the power source 114 to open the clamping assemblies 101. The control unit 113 may send another signal to the power source 114 to close the clamping assemblies 101. If a good grip is not made, the control unit 113 may send signals to open the clamping assemblies 101 and make another attempt to grip the object 110. This method may be continued until a good grip is made. If a good grip is made the lifting assembly 100 may move the clamping assemblies 101 to a specified location for releasing the object 110. The closed loop system 150 may continue this method 110 until an assigned task is finished and/or the sensor 112 does not detect any more objects 110 to be moved.

If an RFID is included on the object, the lifting assembly 100 may query the RFID and remember where the lifting assembly 100 stored the object 110. This may be useful in a storage facility where an operator may request the lifting assembly 100 to transport an object 110 to a certain location. The operator may input a task including the RFID code to designate which object 110 should be moved and a location code to designate where the object 110 should be moved to. The lifting assembly 100 may then independently carry out the operations to fulfill the task.

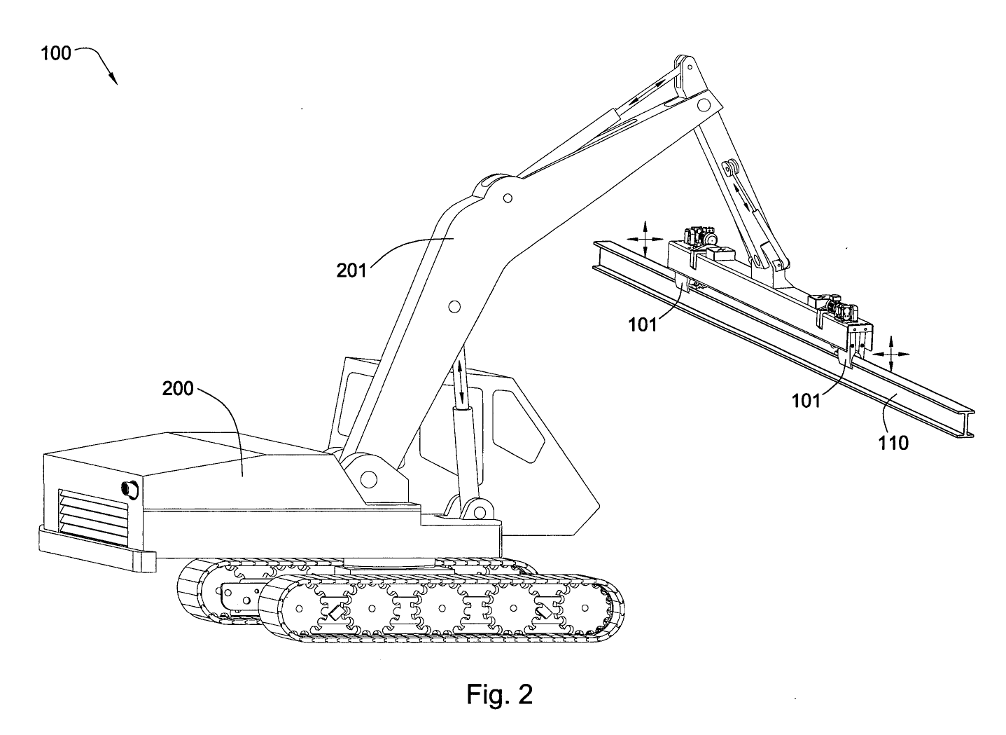

FIG. 2 is a perspective view of a lifting assembly 100 comprising two clamping assemblies 101. The lifting assembly 100 comprises a mobile base 200 and an adjustable arm 201. In this embodiment the lifting assembly 100 may grip objects 110 of varying size, shape, and weight and transport them from one location to another location.

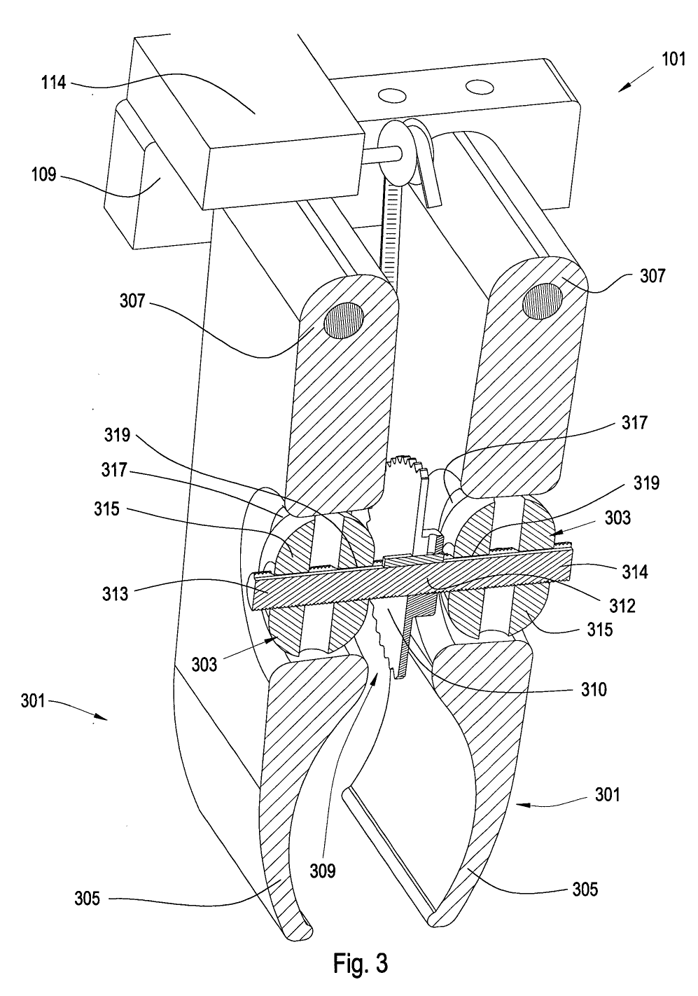

FIG. 3 is a perspective cross-sectional view of a clamping assembly 101 comprising opposed jaws 301 each comprising a ball and socket apparatus 303 intermediate a clamp end 305 and a pivot end 307 attached to a frame structure 109. The ball and socket apparatuses 303 are connected by a gear assembly 309 comprising a primary gear 310 in mechanical communication with a power source 114. Wherein, the jaws 301 are actuated in accordance with the rotation of the primary gear 310.

The gear assembly 309 may comprise a rod 312 comprising the primary gear 310 intermediate oppositely threaded ends 313, 314 threadedly connected to the ball and socket apparatuses 303. The ball and socket apparatuses 303 may comprise a ball 315 pivotally mounted within a corresponding socket 317. The balls 315 of the ball and socket apparatuses 303 may be any shape which may allow the balls 315 to pivot within their corresponding sockets 317. The sockets 317 may extend through the corresponding jaws 301. Each of the balls 315 may further comprise an internally threaded bore 319 adapted for connection to the oppositely threaded ends 313, 314 of the rod 312. The rotation of the rod 312 may cause each of the balls 315 to move linearly in opposite directions along the rod 312. There may be enough friction between the internally threaded bores 319 and the rod 312 to prevent a force generated from the weight of an object 110 held within the jaws 301 to move the balls 315 along the rod 312 and open the jaws 301. This may be advantageous if there is a power failure. The primary gear 310 may be selected from the group consisting of spur gears, helical gears, crossed helical gears, bevel gears, spiral bevel gears, hypoid gears, and zerol gears.

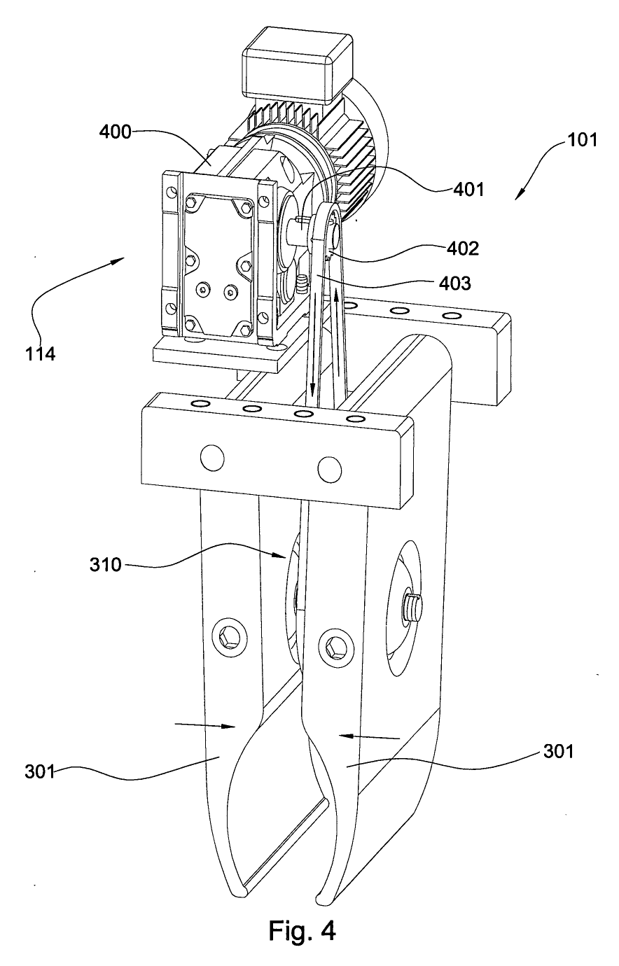

FIG. 4 is a diagram of the clamping assembly 101 with a motor 400 as the power source 114. A shaft 401 on the motor 400 may comprise a second gear 402 in mechanical communication with the primary gear 310. The second gear 402 may be a corresponding spur gear, helical gear, crossed helical gear, bevel gear, spiral bevel gear, hypoid gear or zerol gear. The second gear 402 may also be a worm gear (not shown). The worm gear (not shown) may provide the advantage of being able to turn the primary gear 310 but the primary gear 310 may not be able to turn the worm gear (not shown). This may add safety to the clamping assembly 101 by preventing the jaws 301 from opening during a power failure.

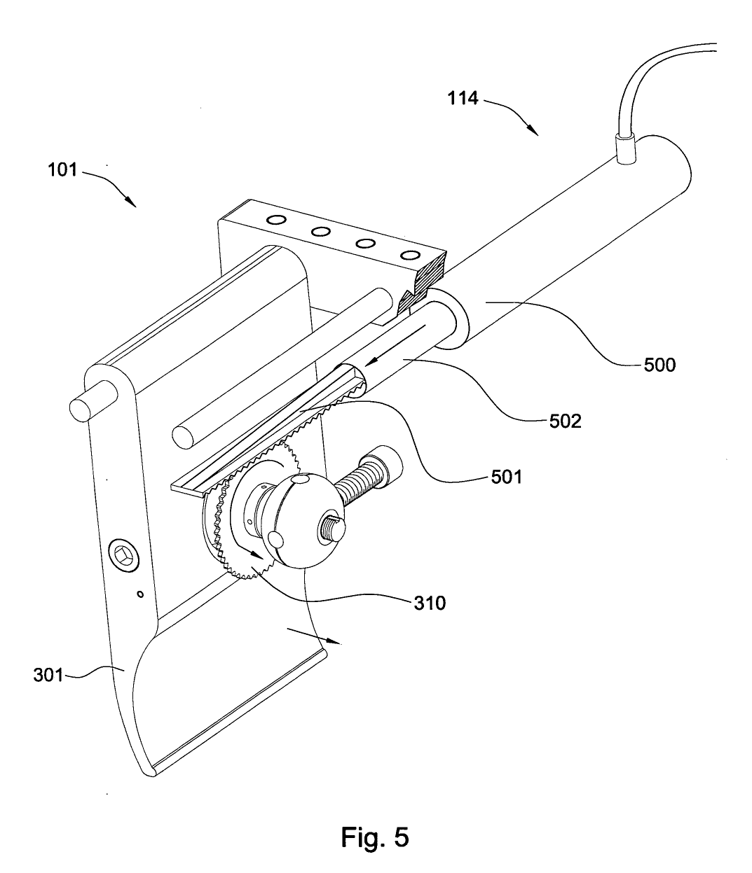

The power source 114 may further be selected from the group consisting of motors, engines and hydraulics. The power source 114 may be in mechanical communication with the primary gear 310 by a mechanical device 403 selected from the group consisting of gears, belts, bands, wheels, pulleys, chains, ropes, rods, shafts, and combinations of the above. FIG. 5 is a diagram of a clamping assembly 101 comprising a hydraulic 500 as the power source 114. A rack gear 501 may be attached to the end of the hydraulic piston 502. The rack gear 501 may be positioned on the primary gear 310 such that the actuation of the hydraulic 500 moves the rack gear 501 along the primary gear 310 resulting in the opening or closing of the clamping assembly 101.

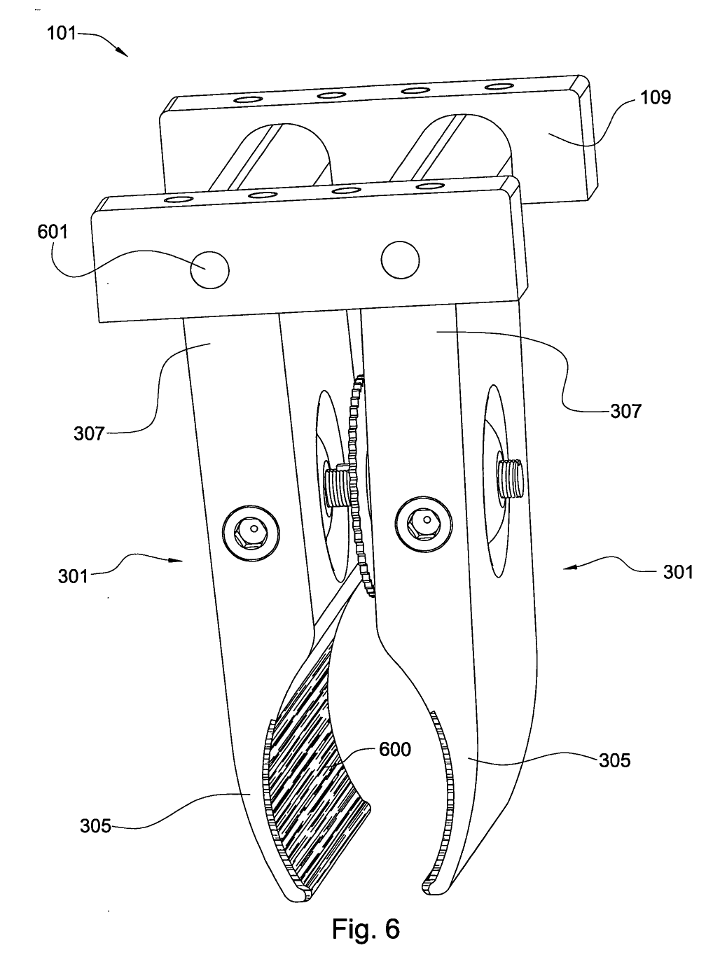

Referring now to FIG. 6, the clamp end 305 of the clamping assembly 101 may comprise a gripping surface 600 selected from the group consisting of elastomers coated surfaces, grooves, curved surfaces and rough surfaces. The pivot end 307 of the jaws 301 may be attached to the frame structure 109 by a connection 601 selected the group consisting of hinges, swivels, ball and sockets apparatuses, and pivots.

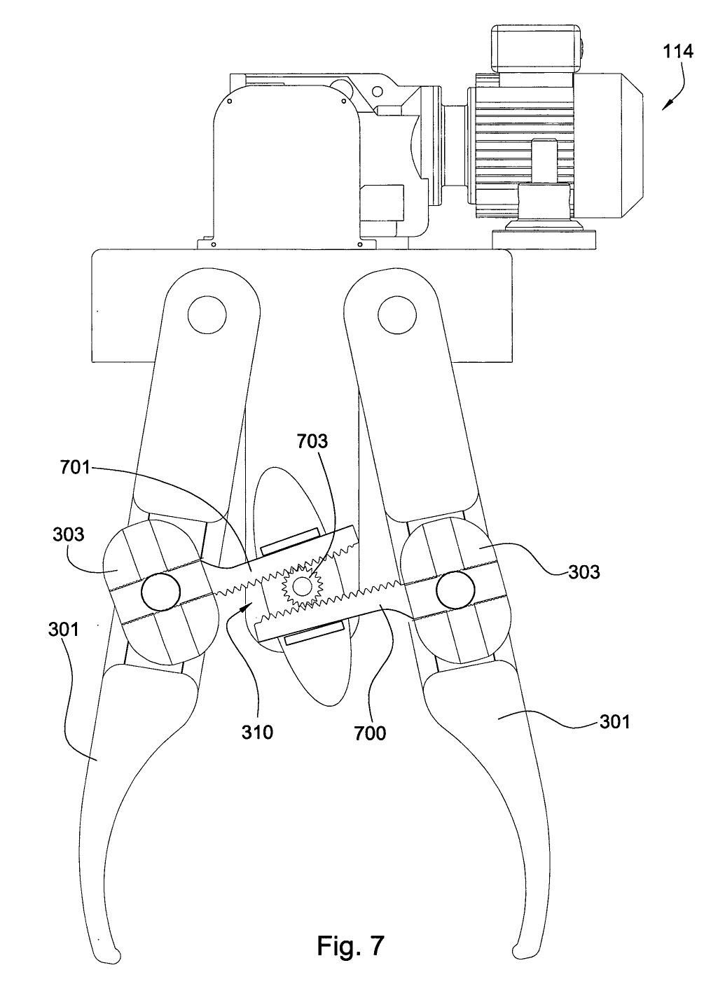

Referring to FIG. 7, the primary gear 310 may further be a pinion gear 703 in mechanical communication with rack gears 700, 701 pivotally connected to opposing ball and socket apparatuses 303. As the pinion gear 703 is actuated by the power source 114 the rack gears 700, 701 placed on opposite sides of the pinion gear 703 may move linearly in opposing directions. This movement may cause the jaws 301 to open or close depending on the direction of rotation of the pinion gear 703.

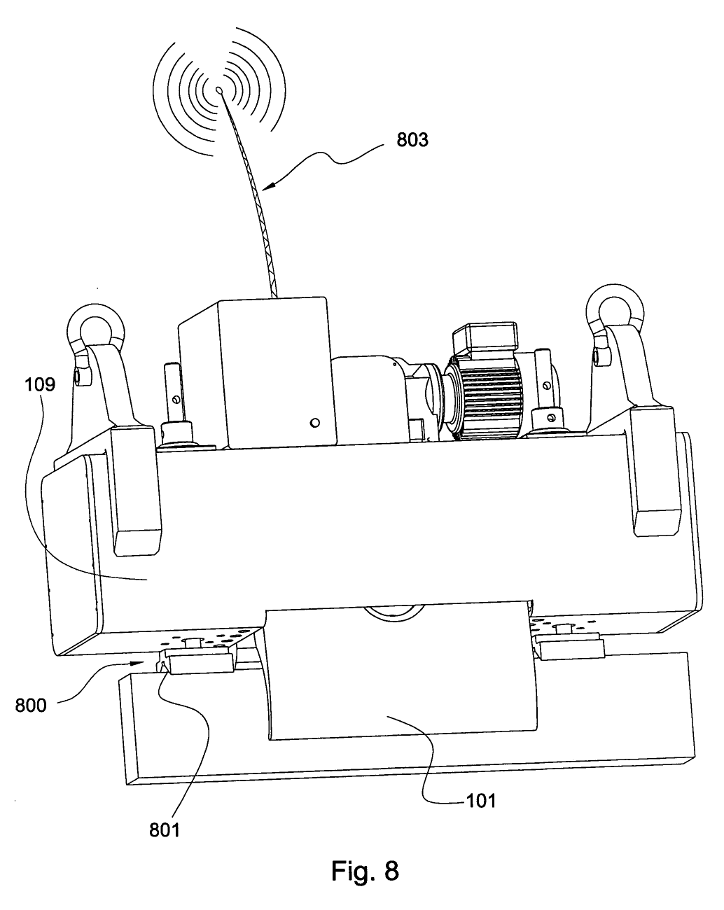

In some embodiments of the present invention, the frame structure 109 may comprises a single clamping assembly 101 as diagramed in FIG. 8. The clamping assembly 101 may comprise an antenna 803 in communication with a remote operator. This may allow the clamping assembly 101 to be controlled wirelessly from a remote location. The frame structure 109 of the clamping assembly 101 may comprise a stabilizing member 800. The stabilizing member 800 may add one or more points of contact 801 between the clamping assembly 101 and the clamped object 110. The stabilizing member 800 may further help in centering the object 110 to be clamped. Because of the added points of contact 801, the position of the object 110 may be known to a more precise degree. This may be useful in an application where the clamping assembly 101 transports objects 110 from a holding location (not shown) to a machine 1402 such as a lathe 1403 as diagramed in FIG. 14. In some aspect of the invention, the stabilizing member 800 may be adjustable manually or electrically through use of a motor and gearing (not shown).

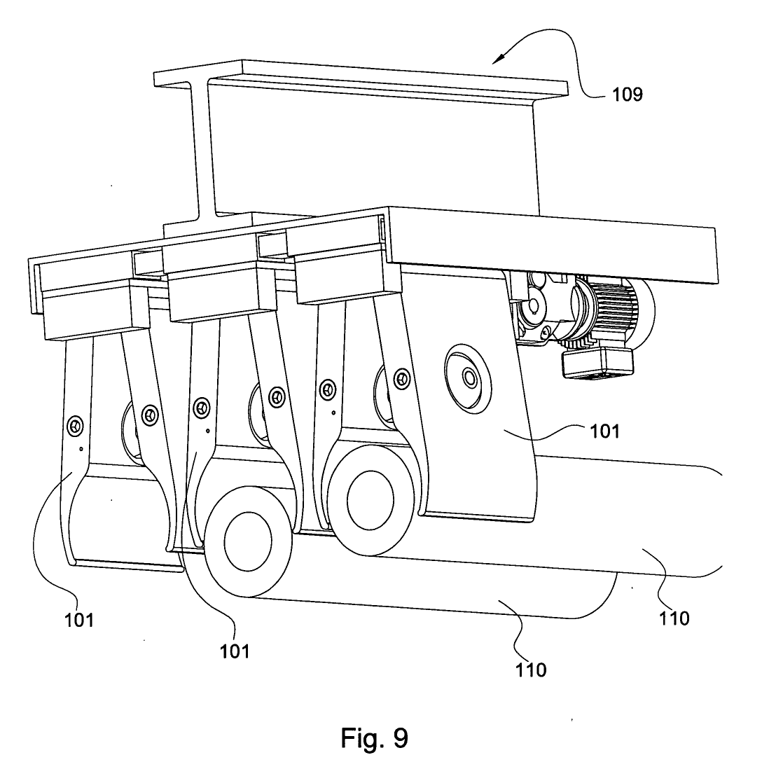

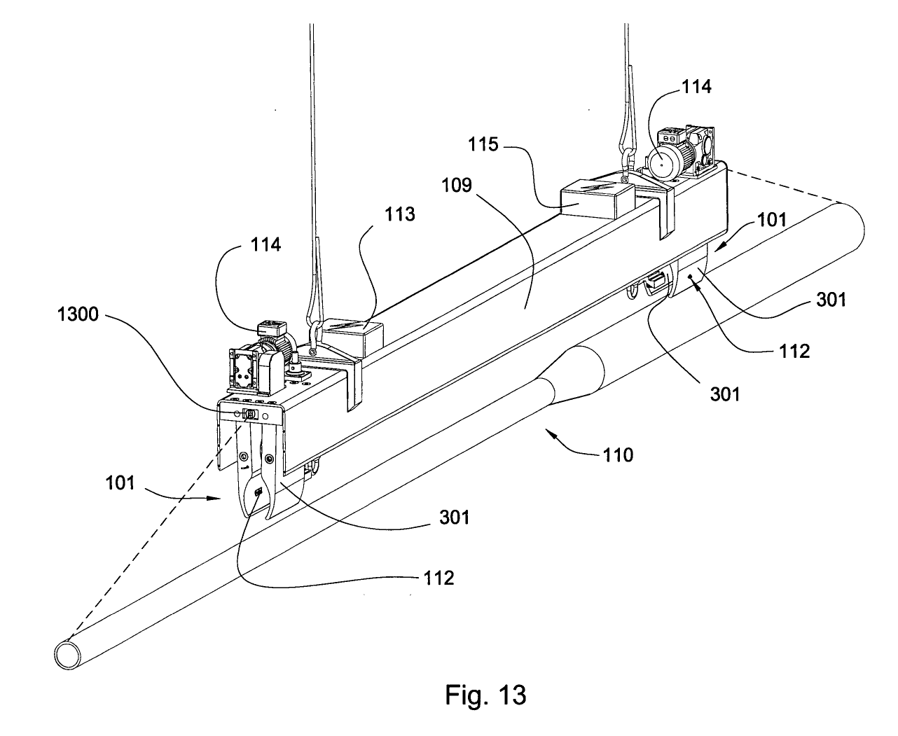

FIG. 9 is a perspective diagram of a frame structure 109 with multiple clamping assemblies 101. The multiple clamping assemblies 101 may be mounted parallel to one another along the frame structure 109. The parallel mounted clamping assemblies 101 may be able to grip objects of varying widths or diameters simultaneously. The clamping assemblies 101 may further be mounted along a common axis 111 as diagramed in FIG. 1. With this orientation the clamping assemblies 101 may be able to grip irregular object 110 with varying widths or diameters see FIG. 13.

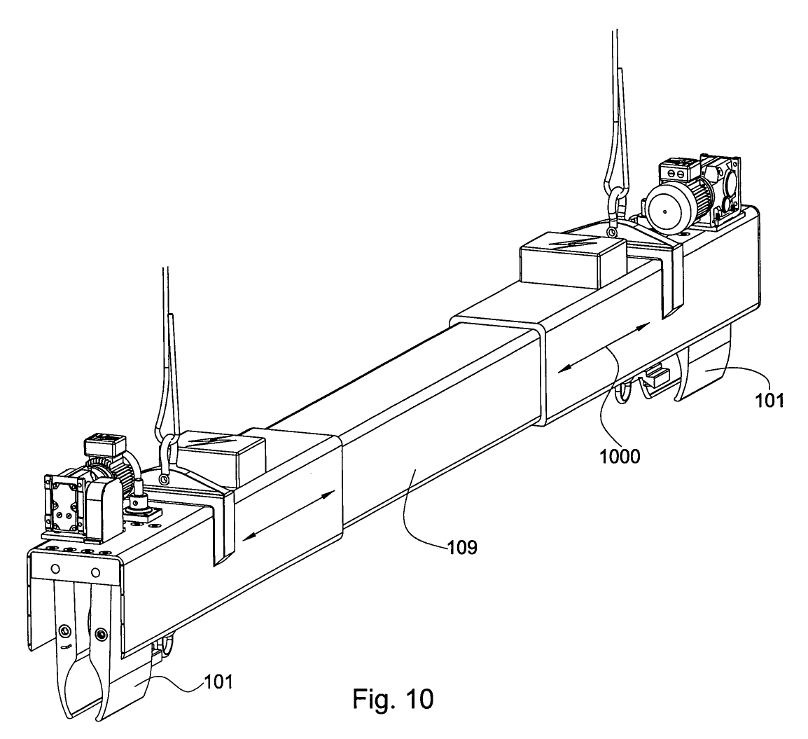

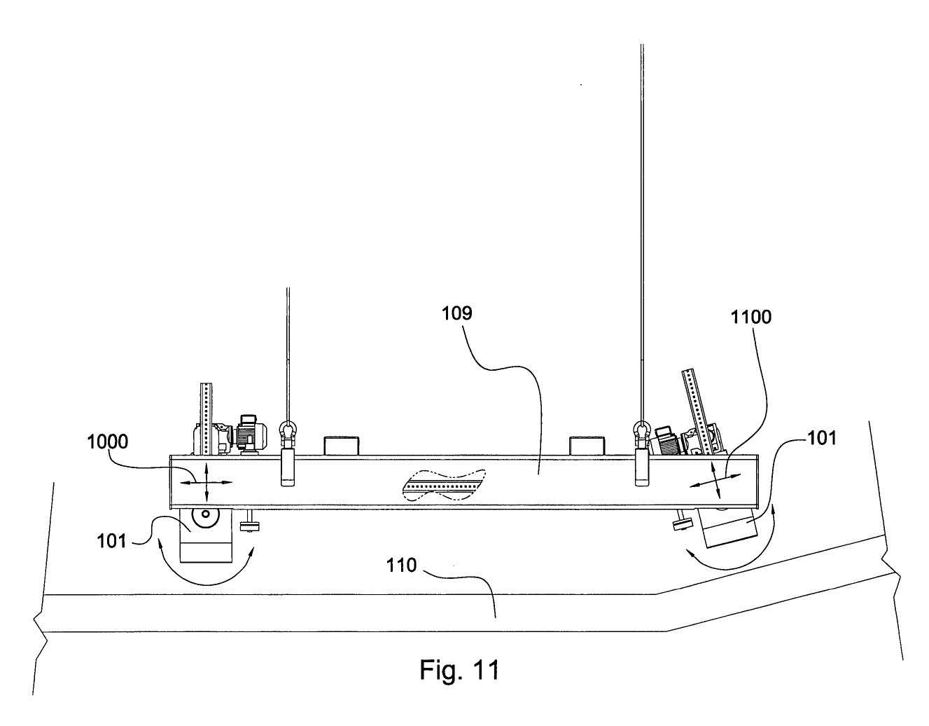

Referring now to FIG. 10, the clamping assemblies 101 are adapted to move in a horizontal direction 1000 along the frame structure 109. The clamping assemblies 101 may be able to move in a vertical direction 1100, a horizontal direction 1000, or both directions 1000, 1100 with respect to the frame structure 109 as diagramed in FIG. 11. The ability to move in a horizontal direction 1000 and vertical direction 1100 along the frame structure 109 may add versatility to the clamping assemblies 101 by accommodating the gripping of objects 110 of varying sizes, shapes, and lengths. FIG. 11 further diagrams shows that the clamping assemblies 101 may rotate with respect to the frame structure 109. This may add more versatility to the clamping assemblies 101 by allowing the clamping assemblies 101 to grip an object 110 positioned at an angle with respect to the frame structure 109 or an object 110 comprising a bend.

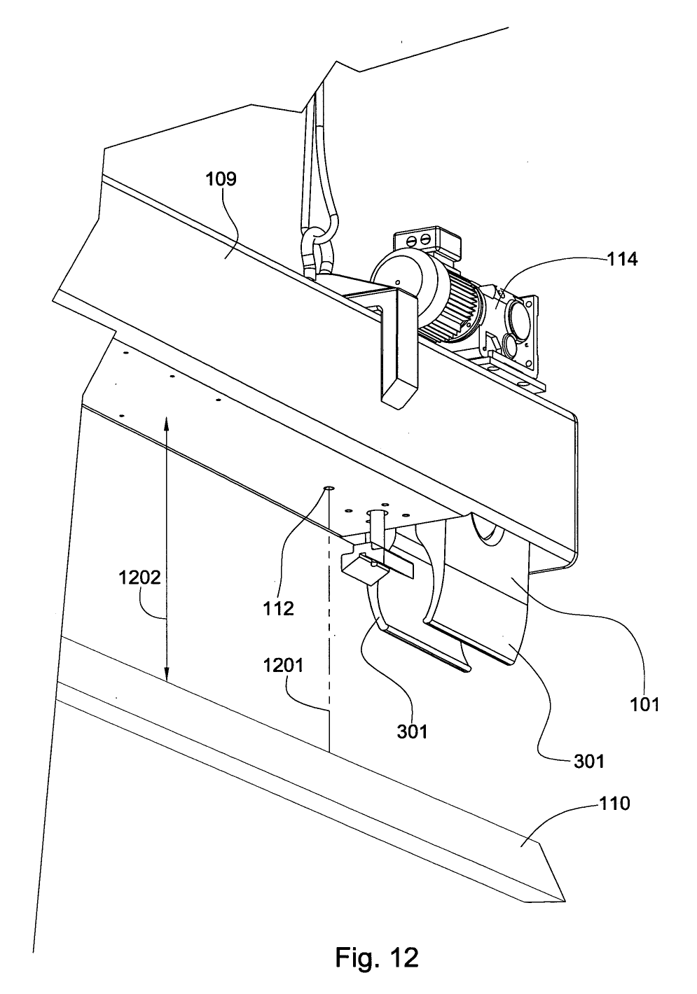

Referring to FIG. 12, the clamping assembly 101 may comprise a sensor 112 selected from the group consisting of torque sensors, pressure sensors, position sensors, strain sensors, optical sensors, sonic sensors, seismic sensors, acoustic sensors, inductive sensors, capacitive sensors, magnetic sensors, temperature sensors, vibrations sensors, sway sensors, smart sensors, and weight sensors. The sensor 112 may be attached on the jaws 301, the power source 114, or the frame structure 109. A torque sensor (not shown) may be used to determine if the clamping assembly 101 has a sufficient grip on the clamped object 110. A smart sensor (not shown) may be made of a smart material. A “Smart material” is a material that changes either its mechanical, electrical, or magnetic properties due to some change in its external environment. A smart sensor may be used to determine if a good grip has been made by determining the amount of stress along the jaws 301. The measured value of stress may then be analyzed with known values to determine the amount of force the jaws 301 are applying around the clamped object 110. A smart sensor 112 may also be useful in determining the position of the object 110 when held within the jaws 301. If the object 110 is not held in a proper position within the jaws 301, the sensors 112 may measure a larger amount of stress along the jaws 301 than would be expected which may signal that a bad grip has been made.

A pressure sensor 112 may also be used to find the amount of force applied to the clamped object 110. An optical sensor 112 may be used to determine the distance of the object 110 relative to the clamping assembly 101. A laser (not shown) may send out a beam of light 1201 and an optical sensor 112 may receive the reflected light which may then be processed to determine the distance 1202 the object 110 is relative to the clamping assembly 101. Acoustic, sonic and seismic sensor may be used to determine the relative position of the clamping assembly 101 with respect to the object 110 by sending a signal out and processing the reflections. Inductive and capacitive sensors may be used to determine if the object 110 is positioned within the jaws 301 far enough to get a good grip by measuring the change in capacitance or inductance that may result when the object 110 to be clamped is within the jaws 301. A sensor 112 may be used in accordance with the jaws 301 to determine the width of the object 110. It is believed that a variety of sensors may be used in a variety of ways and the above reference to certain uses for certain sensors is not meant to limit their scope relating to the present invention.

Referring to FIG. 13, the clamping assembly 101 may comprise a control unit 113 selected from the group consisting of integrated circuits, microprocessor chips and field-programmable gate array's (FPGA's). The clamping assembly 101 may comprise at least a portion of a closed loop system. The at least portion of the closed loop system may comprise elements selected from the group consisting of sensors 112, control units 113, transmission mediums (not shown), power sources 114, actuators (not shown), indicators 1400, 1401 (see FIG. 14), and memory 115.

A sensor 112 in electrical communication with the control unit 113 may determine the position of the clamping assembly 101 with respect to the object 110 to be clamped. The sensors 112 may also determine the length of the object 110 with a laser 1300 or camera (not shown) mounted on each side of the frame structure 109 scanning until the object 110 is reached. The control unit 113 may then be able to take the data received from the sensors 112 and determine the objects 110 length. Once the length of the object 110 is known, the clamping assemblies 101 may be moved along the frame structure 109 into a position that may provide the preferred grip. The control unit 113 may then communicate with the clamping assembly 101 to actuate the power source 114 in order to open and close the jaws 301. When the jaws 301 are closed the control unit 113 may determine through the sensors 112 whether a good or bad grip has been made. If a good grip is indicated, the control unit 113 may then transmit a signal to actuate the power source 114 and open the jaws 301. After the jaws 301 are open the control unit 113 may then send a second signal to actuate the power source 114 and attempt to grip the object 110 a second time. This process may continue until a good grip has been made. The sensors 112 may send a signal to the control unit 113 when the clamping assembly 101 is at the drop off location. The control unit 113 may then send a signal to the power source 114 to open the jaws 301 and release the object 110.

The control unit 113 may receive operating instructions from an input device (not shown) selected from the group consisting of controllers, remote controls, radio controls, sensors, memory, and computers. The operating instructions may be converted into signals to turn on and off the power source 114 of the clamping assembly 101. The operating instructions may be converted into signals to adjust the position and angle of the clamping assembly 101 with respect to the frame structure 109. For example, in embodiments where the frame structure 109 comprises two clamping assemblies 101, if one clamping assembly 101 is failing, a signal may be sent to the other clamping assembly 101 to increase its grip. Further, if a sensor 112 on the clamping assembly 110 measures a sudden increase in weight or torque, the control unit 113 may respond by increasing the grip on the object 110 held within the jaws 301.

The clamping assembly 101 may comprise memory 115. The memory 115 may store operating instructions for routine tasks. The memory 15 may also store values for the control unit 113 to compare with real time values obtained by sensors 112 to determine when the clamping assemblies 101 have a good or bad grip, or when the clamping assemblies 101 are in the correct position. When a bad grip is made or the clamping assemblies are out of position, it may be read as an error and a signal may be sent from the control unit 113 to an indicator 1400 as diagramed in FIG. 14. The indicator 1400 may be a light source or an acoustic source. Indicators 1400, 1401 may be used to indicate a good or bad grip or warn an operator or others nearby of danger such as a power failure or a slipping object. In other aspects of the invention, the indicators 1400, 1401 may be video monitoring devices (not shown). The video monitoring devices (not shown) may send real time images over a network regarding the position and the surroundings of the clamping assemblies 101. This may allow an operator, such as an IntelliLift™ operator, to control numerous lifting assemblies 100 over the network from a single location. This may be advantageous because of the reduction of man hours required to operate the lifting assembly 100. Further, having a remote operator may reduce the need for men to handle hazardous materials such as corrosive or hot material.

Whereas the present invention has been described in particular relation to the drawings attached hereto, it should be understood that other and further modifications apart from those shown or suggested herein, may be made within the scope and spirit of the present invention.

What is claimed is:

1. A clamping assembly, comprising:
opposed jaws each comprising a ball and socket apparatus intermediate a clamp end and a pivot end attached to a frame structure;
the ball and socket apparatuses are connected by a gear assembly comprising a primary gear in mechanical communication with a power source; and
wherein, the jaws are actuated in accordance with the rotation of the primary gear.

2. The clamping assembly of claim 1, wherein the gear assembly comprises a rod comprising the primary gear intermediate oppositely threaded ends threadedly connected to the ball and socket apparatuses.

3. The clamping assembly of claim 1, wherein the primary gear is selected from the group consisting of spur gears, helical gears, crossed helical gears, bevel gears, spiral bevel gears, hypoid gears and zerol gears.

4. The clamping assembly of claim 1, wherein the primary gear is a pinion gear in mechanical communication with rack gears pivotally connected to the ball and socket apparatuses.

5. The clamping assembly of claim 1, wherein the frame structure comprises a stabilizing member.

6. The clamping assembly of claim 1, wherein the clamping assembly comprises a sensor selected from the group consisting of torque sensors, pressure sensors, position sensors, strain sensors, optical sensors, sonic sensors, seismic sensors, acoustic sensors, inductive sensors, capacitive sensors, magnetic sensors, temperature sensors, vibrations sensors, sway sensors, smart sensors, and weight sensors.

7. The clamping assembly of claim 1, wherein the clamping assembly moves in a horizontal direction, a vertical direction or both directions with respect to the frame structure.

8. The clamping assembly of claim 1, wherein the clamping assembly rotates with respect to the frame structure.

9. The clamping assembly of claim 1, wherein the clamping assembly comprises a control unit selected from the group consisting of integrated circuits, microprocessor chips and field-programmable gate array's (FPGA's).

10. The clamping assembly of claim 9, wherein the control unit receives operating instructions from an input device selected from the group consisting of controllers, remote controls, radio controls, sensors, memory, and computers.

11. The clamping assembly of claim 1, wherein the clamping assembly comprises memory.

12. The clamping assembly of claim 1, wherein the clamping assembly comprises at least a portion of a closed loop system.

13. The clamping assembly of claim 12, wherein the at least portion of the closed loop system comprises elements selected from the group consisting of sensors, control units, transmission mediums, power sources, actuators, indicators, and memory.

14. The clamping assembly of claim 1, wherein the power source is selected from the group consisting of motors, engines and hydraulics.

15. The clamping assembly of claim 1, wherein the power source is in mechanical communication with the primary gear by a mechanical device selected from the group consisting of gears, belts, bands, wheels, pulleys, chains, ropes, rods, shafts and combinations of the above.

16. The clamping assembly of claim 1, wherein the clamp end comprises a gripping surface selected from the group consisting of elastomer coated surfaces, grooves, curved surfaces, and rough surfaces.

17. The clamping assembly of claim 1, wherein the pivot end of the jaw is attached to the frame structure by a connection selected the group consisting of hinges, swivels, ball and sockets apparatuses and pivots.

18. A lifting assembly comprising a clamping assembly, comprising:
opposed jaws each comprising a ball and socket apparatus intermediate a clamp end and a pivot end attached to a frame structure of the lifting assembly;
the ball and socket apparatuses are connected by a gear assembly comprising a primary gear in mechanical communication with a power source; and
wherein, the jaws are actuated in accordance with the rotation of the primary gear.

19. The lifting assembly of claim 18, wherein the lifting assembly comprises a sensor selected from the group consisting of torque sensors, pressure sensors, position sensors, strain sensors, optical sensors, sonic sensors, seismic sensors, acoustic sensors, inductive sensors, capacitive sensors, magnetic sensors, temperature sensors, vibrations sensors, sway sensors, smart sensors, and weight sensors.

20. The lifting assembly of claim 18, wherein the lifting assembly comprises at least a portion of a closed loop system.

21. The lifting assembly of claim 20, wherein the at least portion of the closed loop system comprises elements selected from the group consisting of sensors, control units, transmission mediums, power sources, actuators, indicators, and memory.
